(19) United States
(12) Patent Application Publication
(10) Pub. No.: US 2005/0129334 A1
(43) Pub. Date: Jun. 16, 2005

(54) Event photo retrieval system and method

(76) Inventors: Daniel V. Wilder, Ormond Beach, FL (US); Robert A. Fizer, Port Orange, FL (US)

Correspondence Address: Edward M. Livingston, 963 Trail Terrace Drive, Naples, FL, 34103, US

(21) Appl. No.: 10/735,055

(22) Filed: Dec. 12, 2003

(51) Int. Cl. G06K 9/54; G06K 9/00; G06F 17/60

(52) U.S. Cl. 382/305; 382/115; 705/1

(57) ABSTRACT

An event-photo-retrieval system and method has at least one event camera (1), a central database (3), an event-photograph selector (5) and a purchase terminal (6) which are programmed electronically. The event camera includes a digital camera which, for each event attendee (15), quantizes gestalt individual features for programmed face recognition software. The attendee photograph with face recognition software programming is digitized and transmitted to the central database. The event camera photographs event activities for providing event photographs (29) that include event groups (30), event attendees, and event-scenery photographs (10). With the event-photograph selector, event photographs are selectable by the individual attendee in accordance with face recognition software programming. With the purchase terminal, the event attendee actuates a credit-card purchase of any event photographs selected accordingly. An optional data-terminal camera (1) may be used to take pre-event photographs of attendees to which attendee information may be appended and stored in the cental database for photograph identification.

### CROSS-REFERENCE TO RELATED APPLICATION

This is patent application claims the benefit of application Ser. No. 10/346,354 filed on Jan. 17, 2003, entitled “Digital Photographic Storage and Retrieval System for Large Group Events,” now abandoned.

### BACKGROUND OF THE INVENTION

This invention relates to making photographs of event attendees by group-event sponsors for selling the photographs to the attendees and otherwise profiting from the photographs after the group events.

Attendees and participants in group events often desire photographs of their attendance and participation in the group events that most generally include reunions, ship cruises, games, parties, seminars, classes, excursions, safaris, hunts, rallies, conventions, educational activities and political activities. Providing the photographs for the attendees by sponsors of the events can be a profitable business activity and can be advantageous public relations by the sponsors. For some events, the attendees are associated with the sponsor and desire photographs for partly proprietary reasons.

Employing both digital and analog systems, known computer-photographic identification systems can recognize individuals in groups and retrieve photographs containing images of the individuals, but not in a manner taught by this invention. This invention teaches a retrieval system, a method for using it and a method for using existing retrieval systems.

Listed below for consideration is known related prior art:

| U.S. Pat. No. | Inventor | Issue Date |
|---|---|---|
| 6,234,900 | Cumbers | May 22, 2001 |
| 5,893,095 | Jain, et al. | Apr. 6, 1999 |
| 5,642,431 | Poggio, et al. | Jun. 24, 1997 |
| 5,913,205 | Jain, et al. | Jun. 15, 1999 |
| 5,012,522 | Lambert | Apr. 30, 1991 |
| 6,108,437 | Lin | Aug. 22, 2000 |
| 5,450,504 | Calia | Sep. 12, 1995 |
| 6,089,715 | Hoover, et al. | Jul. 18, 2000 |
| 5,719,951 | Shackleton, et al. | Feb. 17, 1998 |

### SUMMARY OF THE INVENTION

Objects of patentable novelty and utility taught by this invention are to provide an event-photo-retrieval system which efficiently, effectively and with good public relations:
allows attendees of group events to select group-event photographs or other photographs containing the individual's desired photograph or other desired aspect of the group-event or other photographs from pluralities of the group-event or other photographs;
allows sponsors of the group events to display photographs of the group-event or individual photographs for sale to the attendees;
automates event photography, selection and selling of desired event photographs to event attendees with minimal labor costs optionally;
makes permanent records of event activities for future uses by event attendees, event hosts and other interested parties; and
provides sponsors of the group events with photographic recordation of attendee and group participation, behavior, activity and response to the group events for monitoring, advertising and other desired reference.

This invention accomplishes these and other objectives with an event-photo-retrieval system and method having an event camera, a central database, an event-photograph selector and a purchase terminal which are programmed electronically. The preferred embodiment includes the event camera photographs event activities for providing event photographs that include event groups and event attendees. An individual attendee desiring to view photographs containing his or her picture for the purpose of possibly purchasing same. With the event-photograph selector, event photographs are selectable by the individual attendee in accordance with face recognition software programming. With the purchase terminal, the event attendee actuates a credit-card purchase of any event photographs selected accordingly. An optimal data-terminal camera includes a digital camera which, for each event attendee, quantizes gestalt individual features and generates an attendee photograph for programmed face recognition software. The attendee photograph with face recognition software programming is digitized and transmitted to the central database.

The above and other objects, features and advantages of the present invention should become even more readily apparent to those skilled in the art upon a reading of the following detailed description in conjunction with the drawings wherein there is shown and described illustrative embodiments of the invention.

### BRIEF DESCRIPTION OF DRAWINGS

This invention is described by appended claims in relation to description of a preferred embodiment with reference to the following drawings which are explained briefly as follows:

FIG. 1 is a schematic diagram of principle features of the event-photo-retrieval system;

FIG. 2 is a schematic diagram of a data terminal camera with quantization of gestalt features of an event attendee in relationship to the event-photo-retrieval system;

FIG. 3 is the FIG. 2 illustration with addition of a switchable touch camera, hidden event cameras and a selection of event photographs;

FIG. 4 is a schematic diagram of the event-photo-retrieval system with a hidden terminal camera and a computerized monitor for an event-photograph selector for touch selection of attendee event photographs containing an attendee photograph;

FIG. 5 is a schematic diagram of the event-photo-retrieval system with the hidden terminal camera and an event-photograph selector having a plurality of photograph copies with selection-mark spaces for selection of attendee event photographs;

FIG. 6 is a schematic diagram of the event-photo-retrieval system with the data terminal camera being switchable for quantization of gestalt features of an event attendee and a compilation listing of attendee event photographs for check-mark selection at a purchase terminal at either an attendee location or business facility of the event host;

FIG. 7 is a schematic diagram of the event-photo-retrieval system articulated for event management and having the hidden data terminal camera for use without knowledge of event attendees; and

FIG. 8 is a schematic diagram of the event-photo-retrieval system articulated for use of other identification software than taught by this invention for optionally marketing attendee event photographs or for event management.

### DESCRIPTION OF PREFERRED EMBODIMENT

Listed numerically below with reference to the drawings are terms used to describe features of this invention. These terms and numbers assigned to them designate the same features throughout this description.
1. Event camera
2 Photographs
3. Central database
4. Data-terminal camera
5. Event-photograph selector
6. Purchase terminal
7. Face recognition software system
8. Attendee-group photographs
9. Event-group photographs
10. Event-scenery photographs
11. Group-object photographs
12. Attendee-object photographs
13. Attendee electronic card
14. Touch-actuation camera
15. Event attendee
16. Camera-touch area
17. Camera switch
18. Hidden terminal camera
19. Host control area
20. Hidden event camera
21. Computerized monitor
22. Attendee-event photographs
23. Photograph copies
24. Selection-mark spaces
25. Event facility
26. Attendee location
27. Event host
28. Business facility
29. Event photographs
30. Event group
31. Compilation listing
32. Identification insignia
33. Identification software system
34. Attendee-purchased photographs
35. Event management
36. Pre-event attendee photographs

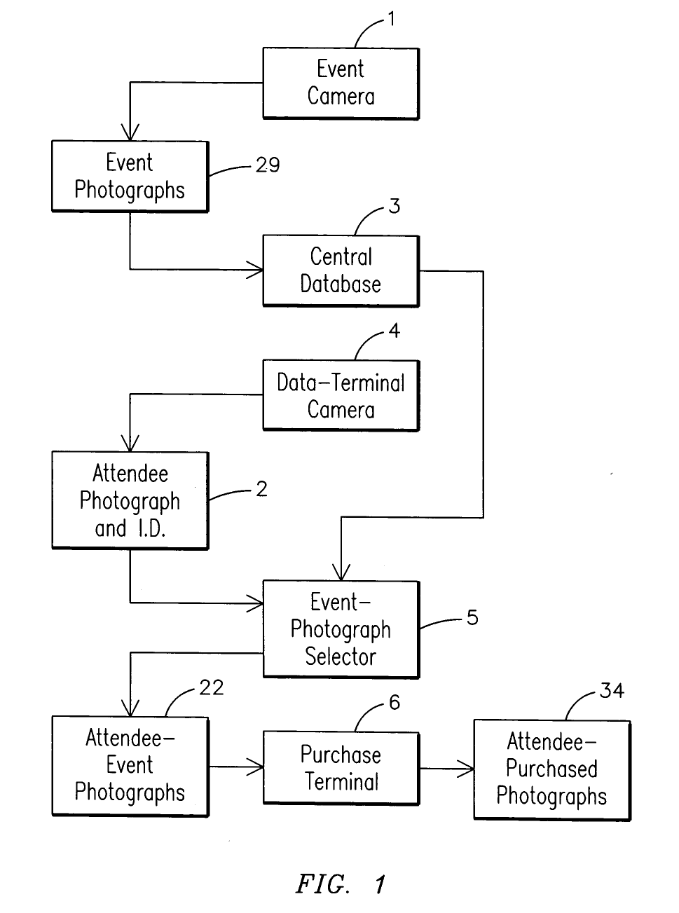

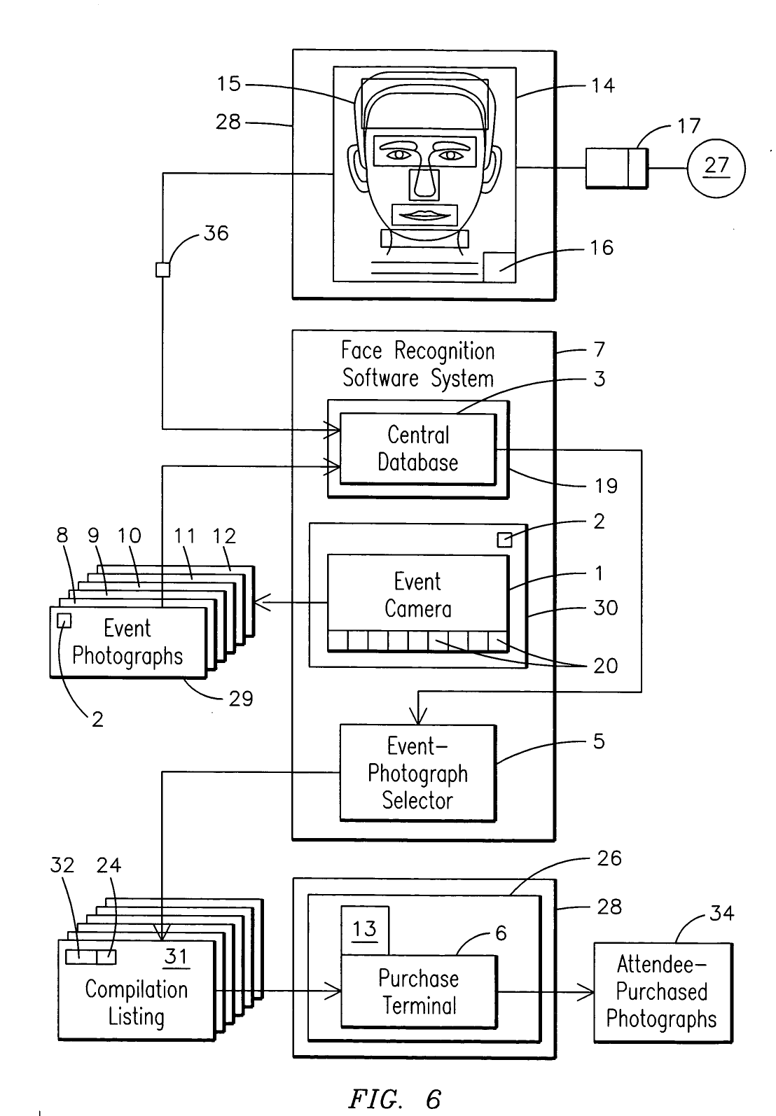

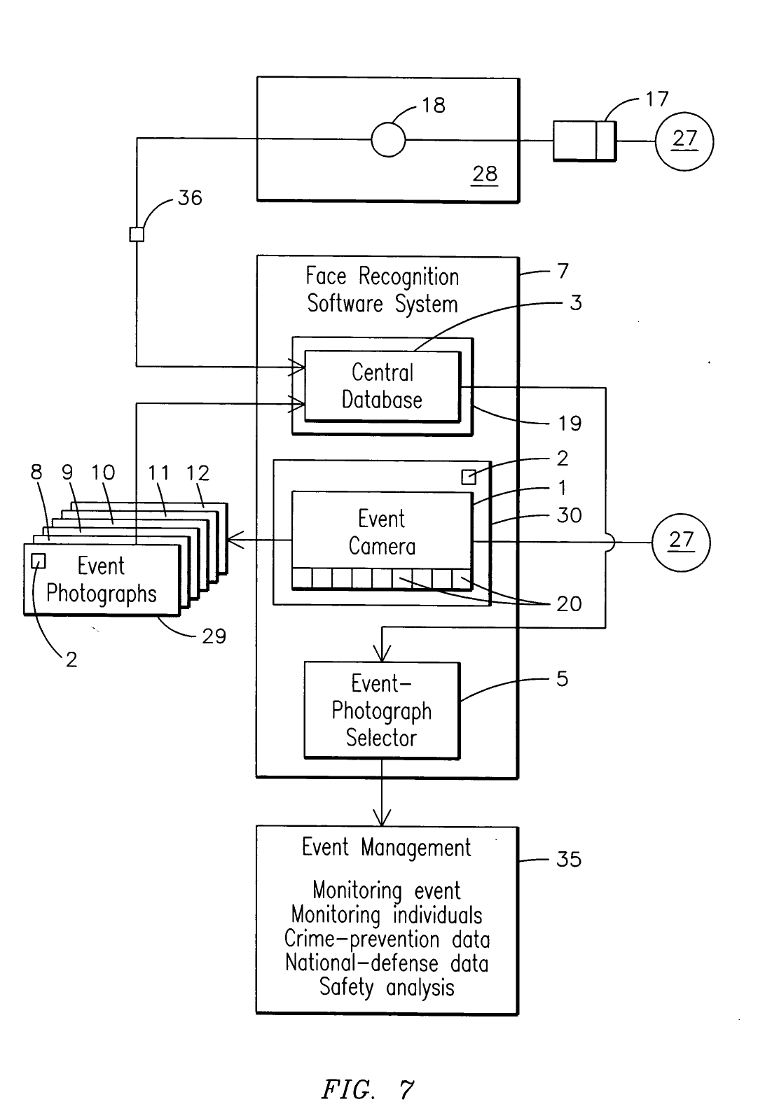

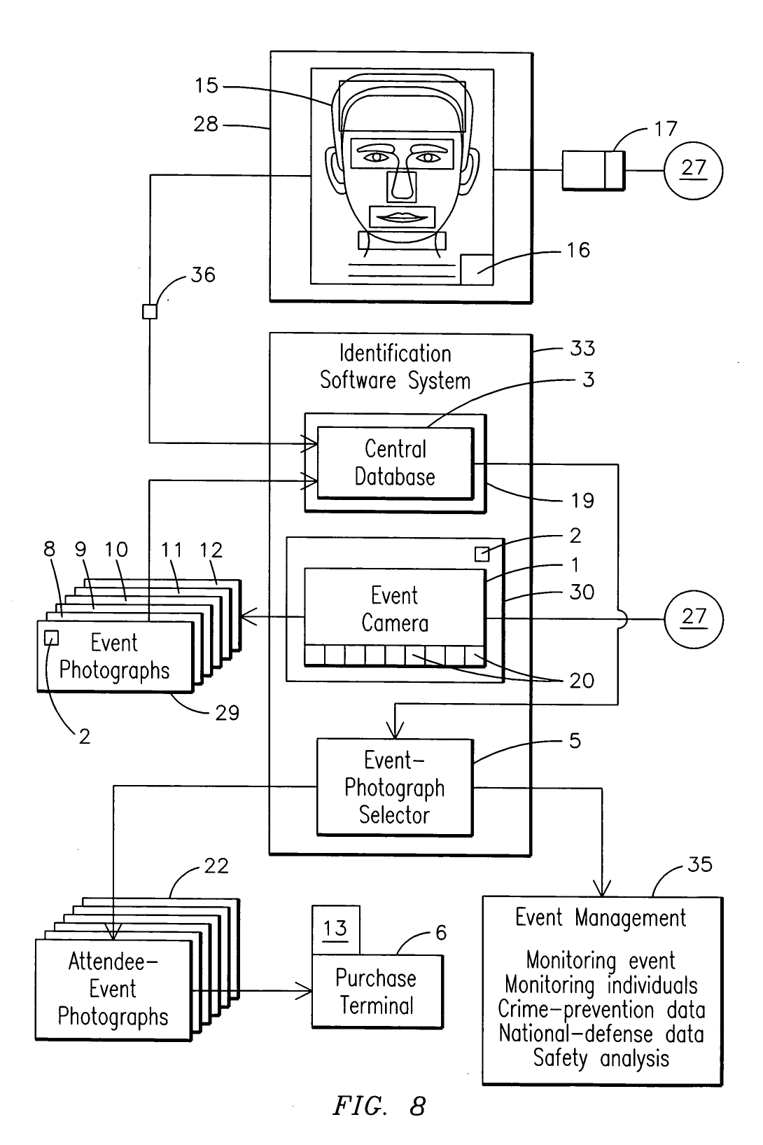

Referring to FIGS. 1-8, the event-photo-retrieval system has an event camera 1 that includes a digital camera which is articulated for generating photographs 2 of event attendees for programmed face recognition software and appended by attendee personal information of an event attendee. The photographs 2 are digitized and transmitted to a central database 3 for being utilized by an event-photograph selector 5 and by a purchase terminal 6 in accordance with a programmed face recognition software system 7.

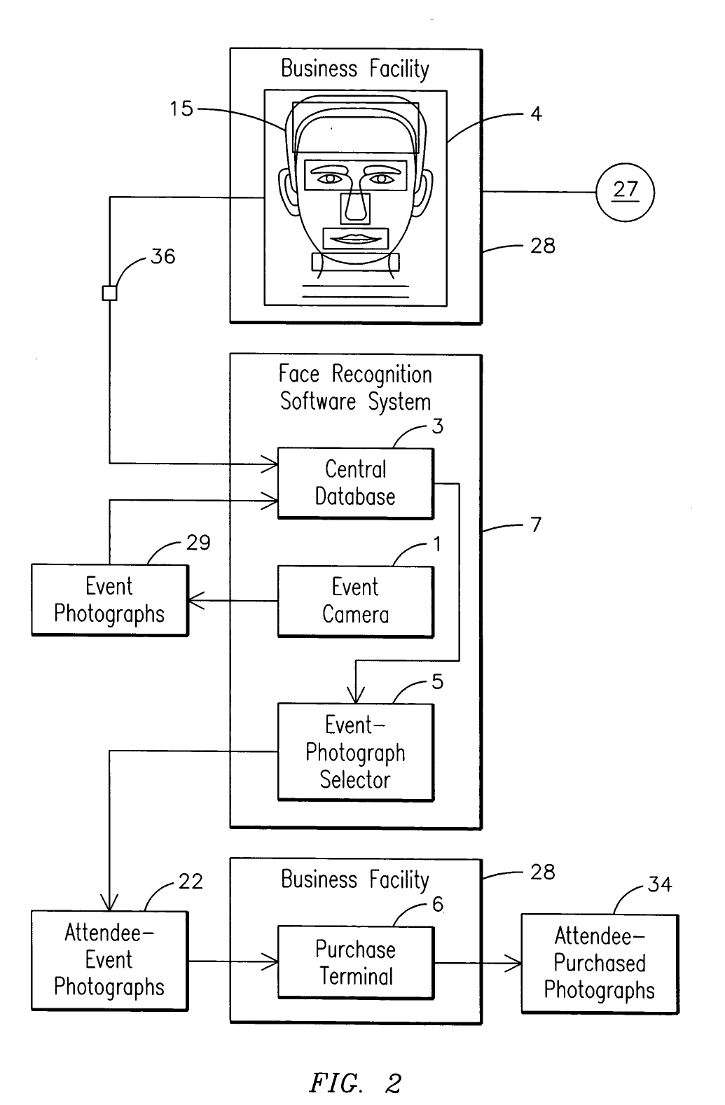

The face recognition software system 7 employs face recognition software that quantizes gestalt features that includes facial features, such as eyes, mouth, forehead, chin and nose, as shown in FIGS. 2-3, 6 and 8, that change form predictably in response to outside stimuli. Following postulations of Gestalt psychology, changes of form of facial features have been quantized precisely to illustrate potential for change of form for specific facial classes. Extensive information is now available for computerized use of gestalt data for individual identification as employed for this invention. It is fundamental to computerized and non-computerized identification systems. It makes identification possible almost regardless of clothing, facial hair, makeup and other concealment.

The event camera 1 is articulated for generating event photographs selectively where and as desired by an event host 27 for purposes of making photographs interesting for purchase by event attendees 15 or optionally for event management 35.

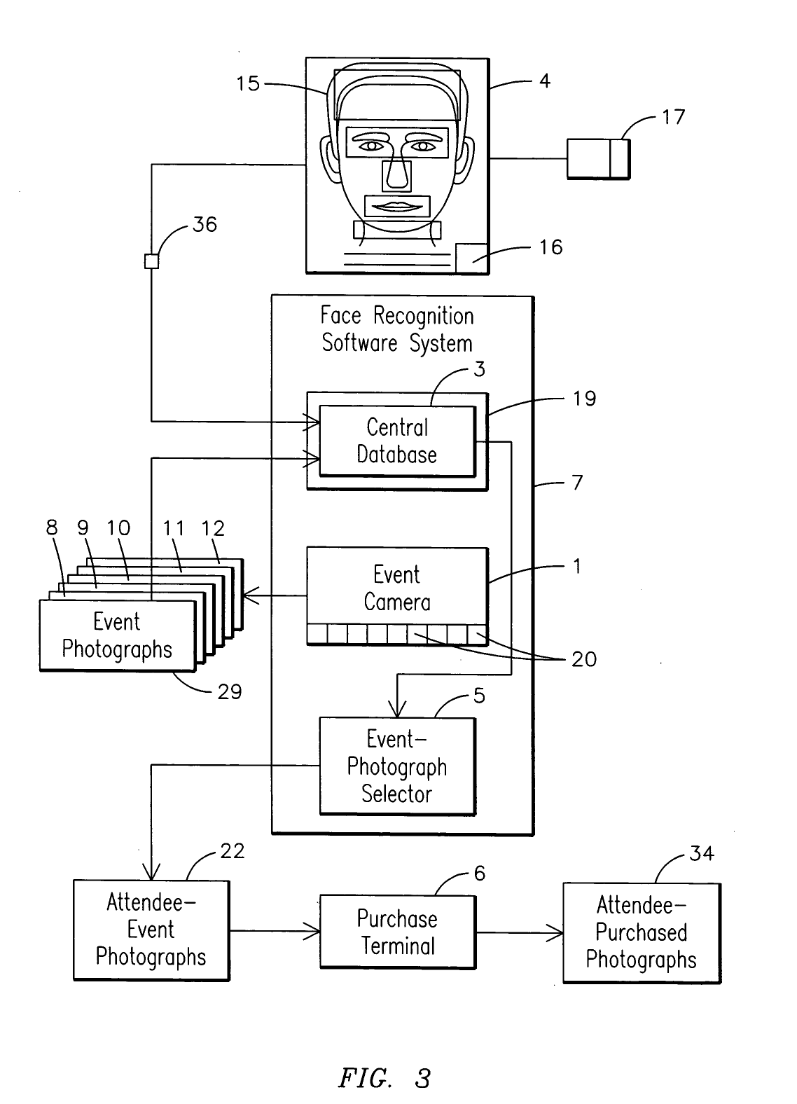

The event-photograph selector 5 is articulated also for utilization of the programmed face recognition software system 7 for the event attendee's retrieval selection of event photographs 29. Included, as shown in FIGS. 3-8, can be attendee-group photographs 8 that are photographs of the event attendee 15 and one or more other members of the event group 30, event-group photographs 9 which include photographs of one or more other members of the event group 30, event-scenery photographs 10 which include photographs of event scenery, group-object photographs 11 which include photographs of event objects and one or more other attendees, and attendee-object photographs 12 which include photographs of event objects and the event attendee 15 selectively.

The purchase terminal 6 is articulated for attendee actuation of an attendee's electronic-card purchase of any of the event photographs 29 selected with an attendee electronic card 13.

An optional data-terminal camera 4 can include a monitor interfaced with a touch-actuation camera 14 that is actuated to take pre-event attendee photographs 36 of the event attendee 15 by a predetermined touch of a camera-touch area 16 after the data-terminal camera 4 is switched on by a camera switch 17 as shown in FIG. 3. The taking of pre-event attendee photographs 36 and appending such with attendee information for storage in the cental database 3 aids identification of photographs with event attendees.

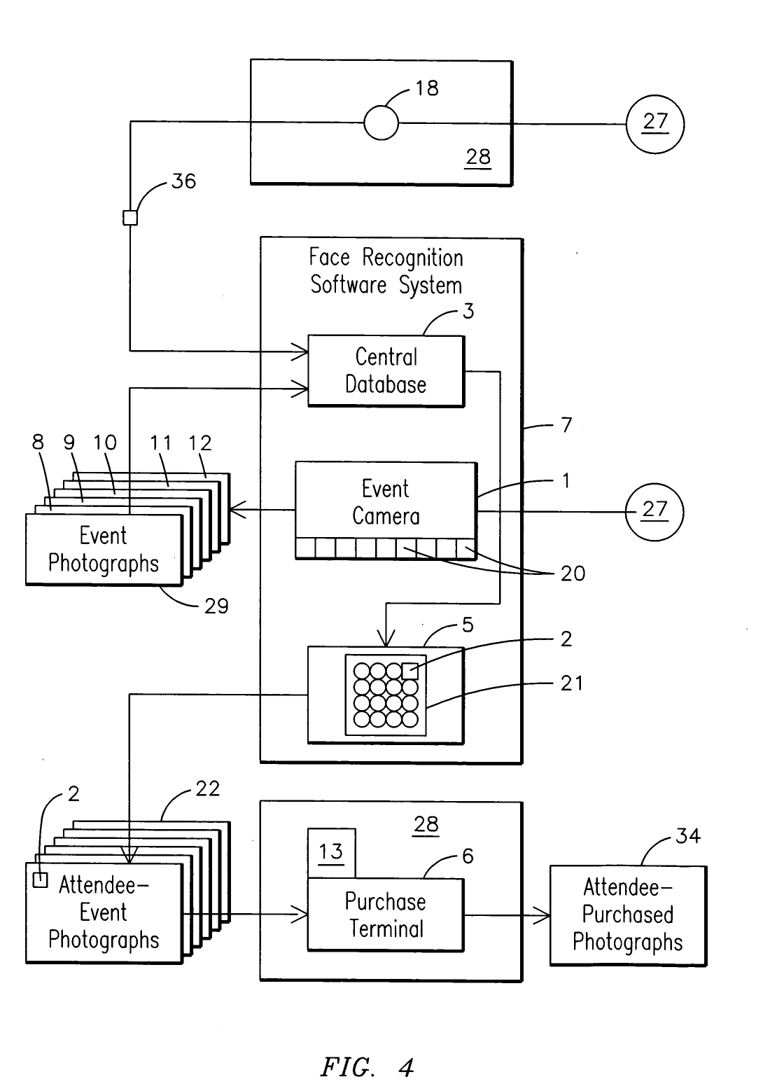

As shown in FIGS. 4-5 and 7, the data-terminal camera 4 can include a hidden terminal camera 18 for allowing event hosts 27 to photograph event-group activities and to photograph attendee activities at events with positive identification for monitoring events without observation by the event attendee 15, for providing selection of photographs for the event attendee 15 and for other attendees as an unexpected benefit of financial returns from sales of photographs with public relations benefits and for utilizing the photographs for desired objectives that include keeping photographic records for government surveillance of events for national security and for crime prevention selectively as legally appropriate.

The central database 3 can be positioned proximate a host control area 19 as shown in FIGS. 3 and 6-8.

The event camera 4 can include a selected plurality of event cameras 1 which can be a selected plurality of hidden event cameras 20 as shown in FIGS. 3-8.

As shown in FIG. 4, the event-photograph selector 5 can include a computerized monitor 21 that is programmed to present any attendee-event photographs 22 for selection selectively. The event-photograph selector 5 can include a computerized monitor 21 that is programmed to present any attendee-event photographs 22 by time of being photographed by the event camera 1 for selection and the computerized monitor 21 can be programmed for selection of the attendee-event photographs 22 for purchase by the event attendee 15 by touch of the photograph 2 for selection of attendee-event photographs 22 containing the touched photograph 2.

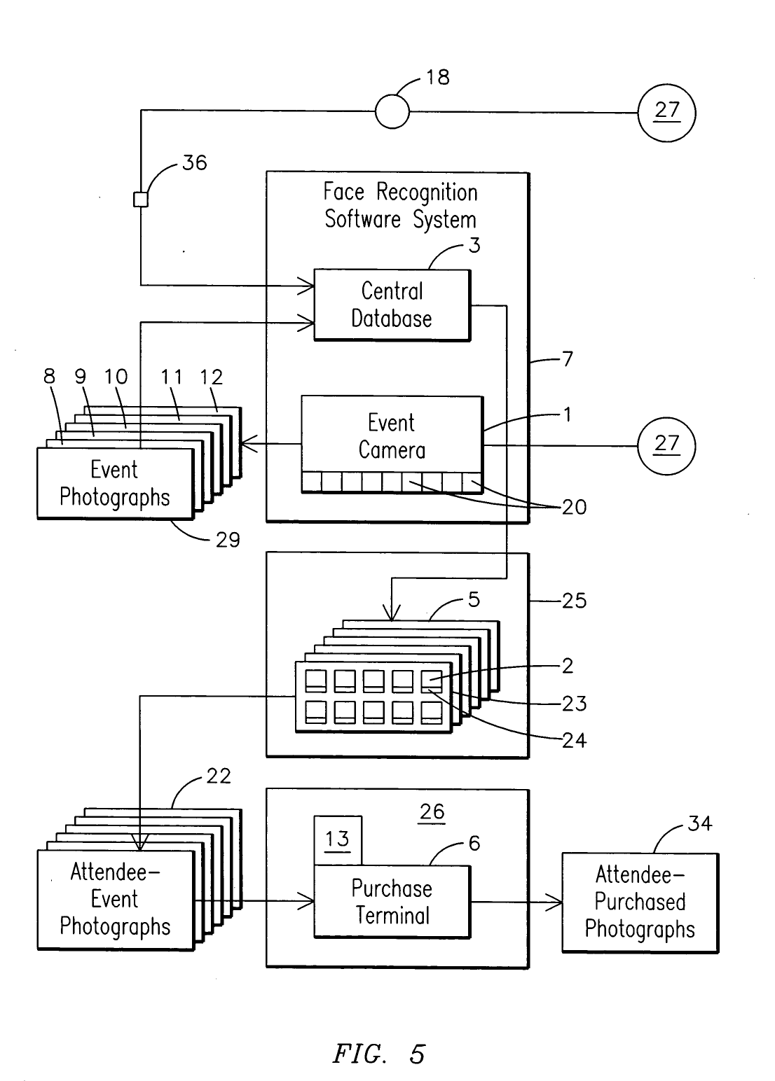

As shown in FIG. 5, the event-photograph selector 5 can include photograph copies 23 that include selection-mark spaces 24 for selecting the photograph copies 23 and marking selection thereof in the selection-mark spaces 24 by a photograph 2 of the event attendee 15 remotely from an event facility 25. The purchase-terminal 6 can include an attendee location 26 which is wherever the event attendee 15 chooses to mark the selection-mark spaces 24 for selecting the attendee-event photographs 22.

The purchase-terminal 6 can include the data-terminal camera 4 being wherever the event host 27 chooses for starting and ending an event for attendance by the event attendee 15. The purchase-terminal 6 can include a business facility 28 which can be wherever the event host 27 chooses for starting and ending an event for attendance by the event attendee 15.

Referring to all FIGS. 1-8 as described above, a method for event-photo retrieval includes:
photographing an event attendee with an event camera that includes a digital camera which is articulated for generating an attendee photograph of an event attendee's facial vicinity that includes quantized gestalt features of the attendee that are identifiable for programmed face recognition software;
digitizing the event photograph;
transmitting the photographs to a central database for being utilized by the digital event camera, by an event-photograph selector and by a purchase terminal selectively in accordance with a programmed face recognition software system;
compiling the event photographs with the quantized gestalt features of the attendee embedded digitally in the event photographs for distinguishing recognition of the event attendee from members of the event group for selection of event photographs containing the attendee photograph;
the event attendee standing before an event-photograph selector, which may comprise viewing screen, which utilizes a face recognition software system to select photographs within which the event attendee appears; and
actuating by the attendee a purchase terminal using an electronic-cord to purchase any of the event photographs selected by the attendee.

Quantizing the gestalt features of the event attendee 15 includes sectioning selected facial features of the event attendee 15, pictorially modifying the selected facial features within physical limits of the selected facial features of the event attendee 15, and compiling pictorial modifications of the selected features for detection of the selected facial features of the event attendee 15 from facial features of other members of the event group 30 digitally.

Quantizing the gestalt features of the event attendee 15 includes sectioning selected combinations of the facial features of the event attendee 15, pictorially modifying the selected combinations of the facial features within physical limits of the selected combinations of the facial features of the event attendee 15, and compiling pictorial modifications of the selected combinations of the features for detection of the selected combinations of the facial features of the event attendee 15 from combinations of the facial features of other members of the event group 30 digitally.

The face recognition software system 7 can include other known facial-recognition and computerized identification systems in combination with this event-photo-retrieval system and method.

Marketing the event photographs 29 can include marketing them to members of the event group 30 by the event host 27 for maximizing volume of attendee-purchased photographs 34.

Marketing the event photographs 29 to the event group 30 can include marketing-them to the event attendee 15.

Marketing the event photographs 29 to the event group 30 by the event host 27 can include providing for the event group 30 a compilation listing 31 of the event photographs 29 for selection of desired event photographs 29 in accordance with the face recognition software system 7 for purchasing the event photographs 29 which may be desired by the members of the event group 30 individually. The members of the event group 30 can be provided with a method for contract for purchase of and payment for the event photographs 29. The method for contract for purchase of and payment for the event photographs 29 by the members of the event group 30 can include the compilation listing 31 of the event photographs 29 by identification insignia 32 appended by selection-mark spaces 24.

The method for contract for purchase of and payment for the event photographs 29 by the members of the event group 30 can include a card-purchase machine for swiping purchase cards of the event group 30 individually proximate the business facility 28 of the event host 27. The method for contract for purchase of and payment for the event photographs 29 by the members of the event group 30 can include conveying by the event host 27 of the compilation listing 31 to the event group 30 at attendee locations 26 for marking selections by the members of the event group 30 in the selection-mark spaces 24 and returning the compilation listing 31 to the event host 27.

The method for use of the event photographs 29 can further include event management 35 by the event host 27. The event management 35 can include monitoring of effectiveness of event activities, analyzing characteristics of individuals of the event group 30 for business objectives of the event host 27 and analyzing characteristics of individuals of the event group 30 for crime-prevention and national-defense objectives of applicable governmental organizations in cooperation with the event host 27.

A method for event-photo retrieval can include photographing of an event attendee 15 by an event host 27 with a data-terminal camera 4 that includes a digital camera which is articulated for generating a photograph 2 and appended identification data in accordance with a class of known identification software system 33 for recognizing and recovering event photographs 29 in which the photograph 2 exists;
transmitting the photograph 2 and appended identification data to a central database 3;
embedding the photograph 2 and appended identification data from the central database 3 into an event camera 1;
utilizing the event camera 1 for generating event photographs 29 in which existence of photographs 2 is identifiable in accordance with the identification software system 33; and
utilizing the central database 3 for the identification software system 33 to provide selection of event photographs 29 by touching the photograph 2 in any event photograph 29 in which the photograph 2 exists.

A method for event-photo retrieval can further include marketing the event photographs 29 to the event group 30 by the event host 27. Marketing the event photographs 29 to the event group 30 by the event host 27 can include providing for the event group 30 a select compilation of the event photographs 29 for selection of desired event photographs 29 in accordance with the identification software system 33 for purchasing the event photographs 29 which may be desired by the members of the event group 30 individually and providing a method for contract for purchase of and payment for the event photographs 29 by the members of the event group 30.

The method for contract for purchase of and payment for the event photographs 29 by the members of the event group 30 can include a card-purchase machine for swiping purchase cards of the event group 30 individually proximate the business facility 28 of the event host 27. The method for use of the event photographs 29 can further include event management 35 by the event host 27. The event management 35 can include monitoring of effectiveness of event activities, analyzing characteristics of individuals of the event group 30 for business objectives of the event host 27 and analyzing characteristics of individuals of the event group 30 for crime-prevention and national-defense objectives of applicable governmental organizations in cooperation with the event host 27.

A new and useful event-photo-retrieval system and method having been described, all such foreseeable modifications, adaptations, substitutions of equivalents, mathematical possibilities of combinations of parts, pluralities of parts, applications and forms thereof as described by the following claims and not precluded by prior art are included in this invention.

1. An event-photo-retrieval system comprising:
an event camera that includes a digital camera being articulated for generating photographs selectively;
a cental database for storing photographs taken using the event camera;
an event-photograph selector being articulated for utilization of a programmed face recognition software system for an event attendee's retrieval selection of event photographs which can include attendee-group photographs that are photographs of the event attendee and one or more other members of the event group, event-group photographs which include photographs of one or more other members of the event group, event-scenery photographs which include photographs of event scenery, group-object photographs which include photographs of event objects and one or more other attendees, and attendee-object photographs which include photographs of event objects and the event attendee selectively; and
a purchase terminal being articulated for attendee actuation of an attendee's electronic-card purchase of any of the event photographs selected by the attendee.

2. The event-photo-retrieval system of claim 1 further comprising:
a data-terminal camera that includes a digital camera being articulated for generating an attendee photograph of an event attendee's facial vicinity that includes quantized gestalt features that are identifiable for programmed face recognition software and appended by attendee personal information of an event attendee; and
the attendee photograph appended by the attendee personal information being digitized and transmitted to a central database for being utilized by an event camera, by an event-photograph selector and by a purchase terminal in accordance with a programmed face recognition software system.

3. The event-photo-retrieval system of claim 2 wherein:
the data-terminal camera includes a monitor interfaced with a touch-actuation camera that is actuated to photograph the event attendee by a predetermined touch of a camera-touch area.

4. The event-photo-retrieval system of claim 2 wherein:
the data-terminal camera includes a hidden terminal camera for allowing event hosts to photograph event group activities and to photograph attendee activities at events with positive identification for monitoring events without observation by the attendee, for providing selection of photographs for the attendee and for other attendees as an unexpected benefit of financial returns from sales of photographs with public relations benefits and for utilizing the photographs for desired objectives that include keeping photographic records for government surveillance of events for national security and for crime prevention selectively as legally appropriate.

5. The event-photo-retrieval system of claim 1 wherein:
the central database is positioned proximate a host control area.

6. The event-photo-retrieval system of claim 1 wherein:
the event camera includes a selected plurality of event cameras.

7. The event-photo-retrieval system of claim 1 wherein:
the event camera includes a hidden event camera.

8. The event-photo-retrieval system of claim 7 wherein:
the event camera includes a selected plurality of hidden event cameras.

9. The event-photo-retrieval system of claim 1 wherein:
the event-photograph selector includes a computerized monitor that is programmed to present any attendee-event photographs for selection selectively.

10. The event-photo-retrieval system of claim 1 wherein:
the event-photograph selector includes a computerized monitor that is programmed to present any attendee-event photographs by time of being photographed by the event camera for selection selectively; and
the computerized monitor is programmed for selection of the attendee-event photographs for purchase by the event attendee by touch of the attendee photograph for selection of attendee-event photographs containing the touched attendee photograph.

11. The event-photo-retrieval system of claim 10 wherein:
the event-photograph selector includes photograph copies that include selection-mark spaces for selecting the photograph copies and marking selection thereof in the selection-mark spaces by an attendee photograph of the event attendee.

12. The event-photo-retrieval system of claim 1 wherein:
the purchase-terminal includes an attendee location which is wherever the event attendee chooses to mark the selection-mark spaces for selecting the attendee-event photographs.

13. The event-photo-retrieval system of claim 1 wherein:
the purchase-terminal includes the data-terminal camera which can be wherever the event host chooses for starting and ending an event for attendance by the event attendee.

14. The event-photo-retrieval system of claim 1 wherein:
the purchase-terminal includes a business facility which can be wherever the event host chooses for starting and ending an event for attendance by the event attendee.

15. A method for event-photo retrieval comprising:
photographing an event attendee with an event camera that includes a digital camera which is articulated for generating an attendee photograph of an event attendee's facial vicinity that includes quantized gestalt features of the attendee that are identifiable for programmed face recognition software;
digitizing the event photograph;
transmitting the photographs to a central database for being utilized by the digital event camera, by an event-photograph selector and by a purchase terminal selectively in accordance with a programmed face recognition software system; and
compiling the event photographs with the quantized gestalt features of the attendee embedded digitally in the event photographs for distinguishing recognition of the event attendee from members of the event group for selection of event photographs containing the attendee photograph.

16. The method of claim 15 wherein:
quantizing the gestalt features of the event attendee includes sectioning selected facial features of the event attendee, pictorially modifying the selected facial features within physical limits of the selected facial features of the event attendee, and compiling pictorial modifications of the selected features for detection of the selected facial features of the event attendee from facial features of other members of the event group digitally.

17. The method of claim 16 wherein:
quantizing the gestalt features of the event attendee includes sectioning selected combinations of the facial features of the event attendee, pictorially modifying the selected combinations of the facial features within physical limits of the selected combinations of the facial features of the event attendee, and compiling pictorial modifications of the selected combinations of the features for detection of the selected combinations of the facial features of the event attendee from combinations of the facial features of other members of the event group digitally.

18. The method of claim 15 wherein:
the face recognition software system includes known facial-recognition and identification-software systems.

19. The method of claim 15 and further comprising:
marketing the photographs to the event group by an event host for maximizing volume of attendee-purchased photographs.

20. The method of claim 19 wherein:
marketing the photographs to the event group includes marketing them to the event attendee.

21. The method of claim 19 wherein:
marketing the photographs to the event group by the event host includes providing for the event group a select compilation of the event photographs for selection of desired event photographs in accordance with the face recognition software system for purchasing the event photographs which may be desired by the members of the event group individually; and
providing a method for contract for purchase of and payment for the event photographs by the members of the event group.

22. The method of claim 21 wherein:
the method for contract for purchase of and payment for the event photographs by the members of the event group includes a compilation listing of the event photographs by identification insignia appended by selection-mark spaces.

23. The method of claim 22 wherein:
the method for contract for purchase of and payment for the event photographs by the members of the event group includes a card-purchase machine for swiping purchase cards of the event group individually.

24. The method of claim 22 wherein:
the method for contract for purchase of and payment for the event photographs by the members of the event group includes conveying by the event host of the compilation listing to the event group at attendee locations for marking selections by the members of the event group in the selection-mark spaces and returning the compilation listing to the event host.

25. The method of claim 15 and further comprising:
utilizing the event photographs by the event host for event management.

26. The method of claim 25 wherein:
the event management includes monitoring of effectiveness of event activities.

27. The method of claim 25 wherein:
the event management includes analyzing characteristics of individuals of the event group for business objectives of the event host.

28. The method of claim 25 wherein:
the event management includes analyzing characteristics of individuals of the event group for crime-prevention and national-defense objectives of applicable governmental organizations selectively in cooperation with the event host.

29. A method for event-photo retrieval comprising:
photographing of event attendees by an event host with an event camera that includes a digital camera which is articulated for generating photographs in accordance with an identification software system for recognizing and recovering event photographs in which the attendee photograph exists;
transmitting the photographs to a central database; and
utilizing the central database for the identification software system to provide selection of event photographs by touching the attendee photograph in any event photograph in which the attendee photograph exists.

30. The method of claim 29 and further comprising:
marketing the photographs to the event group by the event host.

31. The method of claim 30 wherein:
marketing the photographs to the event group by the event host includes providing for the event group a select compilation of the event photographs for selection of desired event photographs in accordance with the identification software system for purchasing the event photographs which may be desired by the members of the event group individually; and
providing a method for contract for purchase of and payment for the event photographs by the members of the event group.

32. The method of claim 31 wherein:
the method for contract for purchase of and payment for the photographs by the members of the event group includes a card-purchase machine for swiping purchase cards of the event group individually.

33. The method of claim 29 and further comprising:
utilizing the photographs by the event host for event management.

34. The method of claim 33 wherein:
the event management includes monitoring of effectiveness of event activities.

35. The method of claim 33 wherein:
the event management includes analyzing characteristics of individuals of the event group for business objectives of the event host.

36. The method of claim 33 wherein:
the event management includes analyzing characteristics of individuals of the event group for crime-prevention and national-defense objectives of applicable governmental organizations selectively in cooperation with the event host.
